(19) United States
(12) Patent Application Publication
(10) Pub. No.: US 2025/0053460 A1
(43) Pub. Date: Feb. 13, 2025

(54) DEEP LEARNING-BASED METHOD FOR PREDICTING HIGH-DIMENSIONAL AND HIGHLY-VARIABLE CLOUD WORKLOAD

(71) Applicant: FUZHOU UNIVERSITY, Fuzhou, Fujian (CN)

(72) Inventors: Zheyi Chen, Fujian (CN); Lixian Chen, Fujian (CN); Bing Xiong, Fujian (CN)

(73) Assignee: FUZHOU UNIVERSITY, Fuzhou, Fujian (CN)

(21) Appl. No.: 18/245,353

(22) PCT Filed: Oct. 20, 2022
(86) PCT No.: PCT/CN2022/126470

§ 371 Date: Mar. 15, 2023

(30) Foreign Application Priority Data
Mar. 31, 2022 (CN) 202210345965.9

(51) Int. Cl. G06F 9/50; G06F 11/34

(52) U.S. Cl. CPC G06F 9/5083; G06F 11/3447

(57) ABSTRACT

The present disclosure relates to a deep learning-based method for predicting a high-dimensional and highly-variable cloud workload, including the following steps: Step S1: obtaining historical workload data of a cloud data center, and carrying out preprocessing; Step S2: on the basis of a raw data set, predicting a future workload of a central processing unit by using a deep learning based prediction algorithm for cloud workloads (L-PAW) integrating a top-sparse auto-encoder (TSA) and a gated recurrent unit (GRU), and transmitting a predicted result to a cloud service provider (CSP); and Step S3: determining, by the CSP, a resource allocation strategy according to the predicted result, such that the cloud data center achieves load balancing. The present disclosure realizes adaptive and effective workload prediction, thereby effectively improving the efficient resource allocation efficiency in cloud computing.

### TECHNICAL FIELD

The present disclosure relates to the field of workload prediction in cloud computing, and provides a deep learning-based method for predicting a high-dimensional and highly-variable cloud workload.

### BACKGROUND

As one of the most prevailing computing paradigms, cloud computing promises on-demand provisioning of computing, storage and networking resources with service level agreements (SLAs) between cloud service providers (CSPs) and users. When user requests arrive simultaneously, workloads burst, so the available resources might be insufficient. On the contrary, an idle status occurs when workloads stay at a lower level, resulting in resource waste. Workload variations lead to the over-allocation or under-allocation of resources, which causes unnecessary overheads or poor SLAs. Therefore, CSPs must be able to rapidly determine resource allocation strategies for guaranteeing SLAs while improving resource utilization. To achieve these objectives, fast and adaptive methods for workload prediction are necessary for cloud computing.

### SUMMARY

In view of this, an objective of the present disclosure is to provide a deep learning-based method for predicting a high-dimensional and highly-variable cloud workload, which realizes adaptive and effective workload prediction, thereby effectively improving the efficient resource allocation efficiency in cloud computing.

To achieve the above objective, the present disclosure adopts the following technical solution:

A deep learning-based method for predicting a high-dimensional and highly-variable cloud workload, including the following steps:
Step S1: obtaining historical workload data of a cloud data center, and carrying out preprocessing;
Step S2: on the basis of a raw data set, predicting a future workload of a central processing unit by using a deep learning based prediction algorithm for cloud workloads (L-PAW) integrating a top-sparse auto-encoder (TSA) and a gated recurrent unit (GRU), and transmitting a predicted result to a cloud service provider (CSP); and
Step S3: determining, by the CSP, a resource allocation strategy according to the predicted result, such that the cloud data center achieves load balancing.

Further, the Step S1 specifically includes:
Step S11: obtaining the historical workload data of the cloud data center, and extracting central processing unit (CPU) utilization as raw workload data, denoted as \vec{X}=(x₁, x₂, . . . , xₙ), wherein n∈ [symbol] , and xₙ is CPU utilization at that time; and
Step S12: normalizing the raw workload data.

Further, the Step S2 of integrating the TSA and the GRU into a recurrent neural network (RNN) to obtain the L-PAW, specifically includes:
replacing a hidden layer of the RNN with a GRU block on the basis of a basic feature representation of the workload extracted by the TSA; and
after the TSA is called to obtain a compressed workload, setting a learning rate decay λ to control a learning rate γ in stages;
where the GRU comprises two gates, namely, an update gate zₜ and a reset gate rₜ, and an update mode of the two gates is on the basis of a current input xₜ^{c} and a previous hidden status ŷₜ₋₁; new memory content ŷₜ is regarded as new information of current time t, and the reset gate rₜ is configured to control whether previous memory needs to be retained; and the update gate zₜ is configured to control the previous memory content ŷₜ₋₁ and the new memory content ŷₜ to be forgotten or added.

Further, compressing the workload data on the basis of the TSA, and extracting a low-dimensional and essential feature representation of the workload data to serve as an input of load prediction, specifically includes:
an input of the TSA being a vector \vec{X}=(x₁, x₂, . . . , xₙ) of a workload example, where nε [symbol] , and xₙ is CPU utilization at a time n;
during forward propagation, an average activation degree \hat{ρ} of hidden units being computed as follows:

$$\hat{ρ} = \frac{1}{n} {\sum }_{i = 1}^{n} [ {a}^{( h )} ( {x}_{i} ) ]$$

where α^{(h)} is an activation function of the hidden layer;
next, all the hidden units being sorted according to respective \hat{ρ} values, and the first k hidden units being recognized, which are denoted as a vector τ=topₖ(\hat{ρ});
computing a cost function J_{TSA}(W, b)=J(W, b)+βΣⱼ₌₁^{k}KL(ρ∥\hat{ρ}ⱼ) of the TSA, and
compressed workload data xₙ^{c}=Wxₙ+b, where W is a weight and b is a bias; and
executing backpropagation of the cost function J_{TSA}(W, b) through τ=topₖ(\hat{ρ}).

Further, the k hidden units with the highest activation degree are selected to reconstruct input data.

Compared to the prior art, the present disclosure has the following beneficial effects:

The present disclosure realizes adaptive and effective workload prediction, thereby effectively improving the efficient resource allocation efficiency in cloud computing.

### BRIEF DESCRIPTION OF THE DRAWINGS

FIG. 1 is a prediction model in the present disclosure;

FIG. 2 is a network structure of a top-sparse auto-encoder (TSA) in an embodiment of the present disclosure;

FIG. 3 is a structure of a gated recurrent unit (GRU) block in a deep learning based prediction algorithm for cloud workloads (L-PAW) according to an embodiment of the present disclosure;

FIG. 4 is the evaluation for performance of data compression on the TSA by k different hidden units in an embodiment of the present disclosure;

FIG. 5 is the prediction accuracy (mean square error (MSE)) of different recurrent neural network (RNN) based methods having different prediction lengths in an embodiment of the present disclosure; and

FIG. 6 is the performance comparison between the L-PAW and other classic methods for workload prediction in an embodiment of the present disclosure.

### DETAILED DESCRIPTION OF THE EMBODIMENTS

The present disclosure is further described below in conjunction with the accompanying drawings and the embodiments.

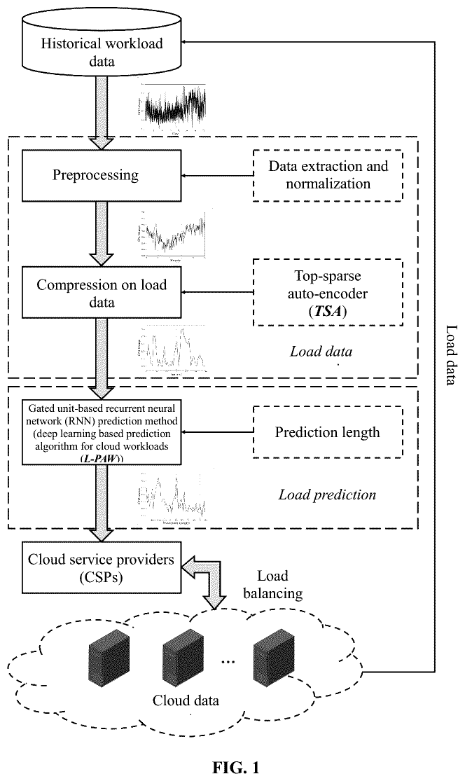

Referring to FIG. 1, the present disclosure provides a deep learning-based method for predicting a high-dimensional and highly-variable cloud workload, including the following steps:
Step S1: obtaining historical workload data of a cloud data center, and carrying out preprocessing;
Step S2: on the basis of a raw data set, predicting a future workload of a central processing unit by using a deep learning based prediction algorithm for cloud workloads (L-PAW) integrating a top-sparse auto-encoder (TSA) and a gated recurrent unit (GRU), and transmitting a predicted result to a cloud service provider (CSP); and
Step S3: determining, by the CSP, a resource allocation strategy according to the predicted result, such that the cloud data center achieves load balancing.

In this embodiment, central processing unit (CPU) utilization is taken as a main performance metric of the workload, and the metric is extracted in the workload preprocessing and is denoted as \vec{X}=(x₁, x₂, . . . , xₙ), where n∈ [symbol] , xₙ is CPU utilization at that time. Since there exists a huge difference in a value range of the workload data within different time intervals, raw workload data needs to be normalized before the next step is performed. In this embodiment, one of the most widely used standardization methods in machine learning (i.e. standardization) is adopted as follows:

$${x}^{′} = \frac{x - mean ( \vec{X} )}{σ} \qquad ( formula 1 )$$

where mean(\vec{X}) is a mean of \vec{X}, and σ={square root over (E(\vec{X}²)−(E(\vec{X}))²)} is a standard deviation.

After preprocessing, normalized workload data \vec{X}′ is forwarded to workload compression. The high dimensionality and redundancy of the workload data seriously reduce the prediction accuracy and lead to high computational complexity. Therefore, the TSA is proposed to compress the workload data and effectively extract a low-dimensional and essential feature representation of the workload data to serve as an input of gated recurrent neural network (RNN)-based workload prediction in the next step. By using standardized and compressed historical workload data, the future workload of the central processing unit is predicted and transmitted to the CSP, and the CSP determines the appropriate resource allocation strategy by using these predictions.

In this embodiment, a gated RNN-based learning method L-PAW is proposed, which is configured for capturing long-term memory correlation from a historical workload, so as to predict a time series problem more accurately. Before the workload is predicted by means of the L-PAW, the CPU utilization of each recorded trace measured within each time interval is added into the historical workload and serves as an input of the RNN. By setting a time length of prediction, future workloads in different periods of time may be predicted. Then, the accuracy of workload prediction is measured by using a mean square error (MSE).

$$M S E = \frac{1}{N} {\sum }_{i = 1}^{N} {( {\hat{y}}_{i} - {y}_{i} )}^{2} \qquad ( formula 2 )$$

where N represents the time length of prediction, and ŷₗ and yᵢ are respectively a predicted workload and an actual workload.

Preferably, a top-sparse auto-encoder is designed to effectively extract the low-dimensional and essential feature representation of the workload data. Then, the TSA and the GRU are integrated into the RNN to capture long-term memory dependence from the historical workload for achieving efficient and accurate workload prediction.

Algorithm 1: Top-Sparse Auto-Encoder (TSA)

```
  1. Input: workload data \vec{X} = (x₁, x₂, ... , xₙ)
  2. Initialize: hidden units Nₕ with a highest activation degree k, where k < Nₕ
  3.  for each training epoch n = 0, 1, 2, ... , N do :
  4.  for each hidden unit j = 1, 2, ... , Nₕ do :
  5.  Execute forward propagation and compute an average activation degree \hat{ρ}ⱼ =
$\frac{1}{n} {\sum }_{i = 1}^{n} [ {a}_{j}^{( h )} ( {x}_{i} ) ] of the hidden units$
  6.  end
  7.  Select top k hidden units from maximum \hat{ρ}, and setting others to be 0, \hat{p}_{(τ)}^{c} =
0, where τ = topₖ(\hat{ρ})
  8.  Compute a cost function J_{TSA}(W, b) = J(W, b) + β Σⱼ₌₁^{k} KL(p || \hat{ρ}ⱼ) of the
TSA
  9.  Output compressed workload data xₙ^{c} = Wxₙ + b
10.  Execute backpropagation of the cost function J_{TSA}(W, b) through τ = topₖ(\hat{ρ})
11. end
```

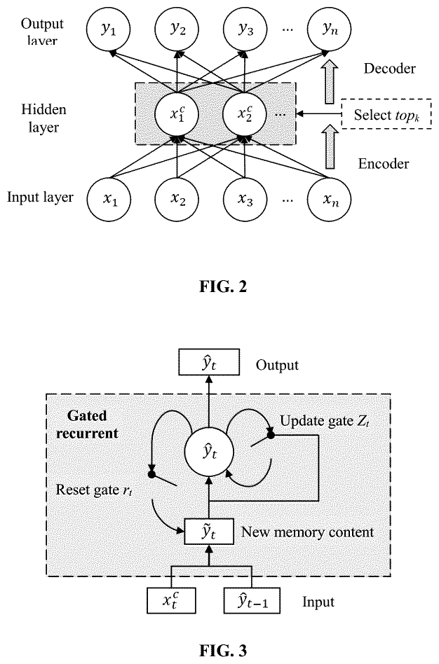

As shown in FIG. 2, an input of the TSA is a vector \vec{X}=(x₁, x₂, . . . , xₙ) of a workload example, where n∈ [symbol] , and xₙ is CPU utilization at a time n.

Similar to SA, the TSA also tries to approximate an identity function yₙ=ƒ(Wxₙ+b)≈xₙ such that an output yₙ may be close to an input xₙ. Generally, the SA is a combination of a linear activation function and a fixed weight, which usually leads to excessive use of the hidden units and low learning efficiency. The proposed TSA may also be regarded as an improved form of the SA, where input data is reconstructed by selecting the k hidden units with the highest activation degree, instead of using all the hidden units like the SA. During forward propagation, an average activation degree \hat{ρ} of each hidden unit is computed as follows:

$$\hat{ρ} = \frac{1}{n} {\sum }_{i = 1}^{n} [ {a}^{( h )} ( {x}_{i} ) ] \qquad ( formula 3 )$$

where α^{(h)} is an activation function of the hidden layer.

Next, all the hidden units are sorted according to respective \hat{ρ} values, and the first k hidden units may be recognized, which are denoted as a vector τ=topₖ(\hat{ρ}). Therefore, nonlinear computing only occurs during processing of topₖ(\hat{ρ}), which greatly reduces the computational complexity compared to the SA. More specifically, the value of k affects the similarity between the workload data before and after compression. For example, when the TSA uses a smaller value of k (fewer hidden units), it cannot fully capture the features of the raw data, which distorts the compressed data. On the contrary, the TSA may include a lot of redundant information and use a larger value of k (more hidden units), which increases the complexity of subsequent prediction. The key steps of the proposed TSA are as shown in Algorithm 1. The complexity of Algorithm 1 is O(n), linear to a size n of the hidden layer in the TSA.

Therefore, the problem of workload compression is transformed into the computation J_{TSA}(W, b) for the weight W and the bias b by minimizing the cost function. In particular, the cost function J(W, b) of a standard neural network is as follows:

$$J ( W , b ) = \frac{λ}{2 n} {\sum }_{l = 1}^{2} {\sum }_{i = 1}^{{s}_{l}} {\sum }_{j = 1}^{{s}_{l + 1}} {( {W}_{ji}^{( l )} )}^{2} + \frac{1}{n} {\sum }_{i = 1}^{n} ( \frac{1}{2} {‖ {x}_{i} - {y}_{i} ‖}^{2} ) \qquad ( formula 4 )$$

where the first item is the regularization for avoiding overfitting, and the second item is the mean square error between the raw workload data xᵢ and decoded data yᵢ.

To merge the Kullback-Leibler (KL) divergence into the computation for derivative, a raw derivative of the hidden layer during backpropagation is modified as an equation. During forward propagation, all training samples should be computed to obtain the average activation degree \hat{ρ}ᵢ before processing to backpropagation.

$${δ}_{i}^{( h )} = [ {\sum }_{j = 1}^{{N}_{o}} {δ}_{j}^{( o )} {W}_{ji}^{( h )} + β ( - \frac{ρ}{{\hat{ρ}}_{i}} + \frac{1 - ρ}{1 - {\hat{ρ}}_{i}} ) ] {f}^{′} ( {z}_{i}^{( h )} ) \qquad ( formula 5 )$$

where N₀ is the number of output units, and ƒ′(zᵢ^{(h)}) is the derivative of activation ƒ(zᵢ^{(h)})=αᵢ^{(h)}.

Then, the compressed workload is taken as a high-level feature representation of the raw data and is taken as an input vector of RNN-based workload prediction, which is denoted as \vec{X}^{c}=(x₁^{c}, x₂^{c}, . . . , xₜ^{c}). It is assumed that a vector of the predicted workload is \vec{Y}=(ŷ₁, ŷ₂, . . . ,ŷₜ), and then a prediction model is trained by comparing an error between the predicted workload ŷₜ and the actual workload xₜ₊₁^{c}, where xₜ₊₁^{c} represents the actual workload at a time t+1.

Especially, backpropagation through time (BPTT) is adopted as a training algorithm for the RNN. When there exists only a short time interval between the historical workload and the predicted workload, the RNN may learn useful information for effective prediction. However, the RNN reads and updates all previous information. As the time interval increases, the accumulation of gradients in the RNN is close to 0. Therefore, network parameters of the RNN cannot be updated effectively, and the RNN fails to learn gradually. This problem is known as gradient vanishing and may also be expressed as the poor ability to capture the long-term memory dependence. Therefore, the historical workload for a long time cannot be effectively configured for workload prediction through a conventional RNN structure.

In this embodiment, the hidden layer of the classic RNN is replaced with the GRU block on the basis of the basic feature representation of the workload extracted by the proposed TSA.

The key steps of the L-PAW are as shown in Algorithm 2. After the TSA is called to obtain the compressed workload, one learning rate decay λ is set to control a learning rate γ in stages, so as to achieve more effective learning in different stages of training the neural network. To solve the problem of gradient vanishing in the conventional RNN structure, some gated RNNs such as long short term memory (LSTM) and GRU are proposed.

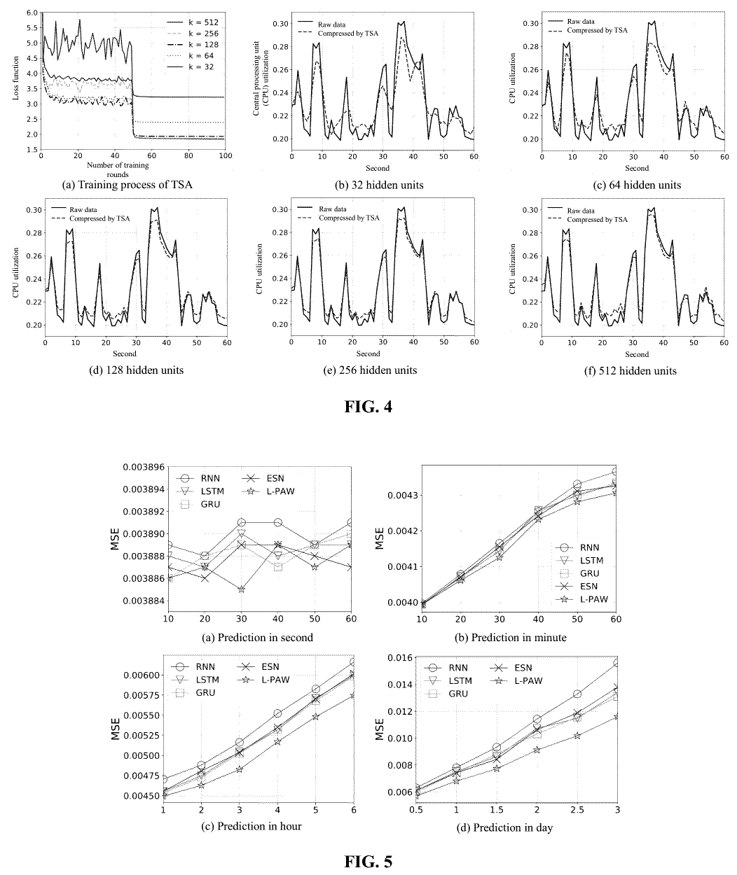

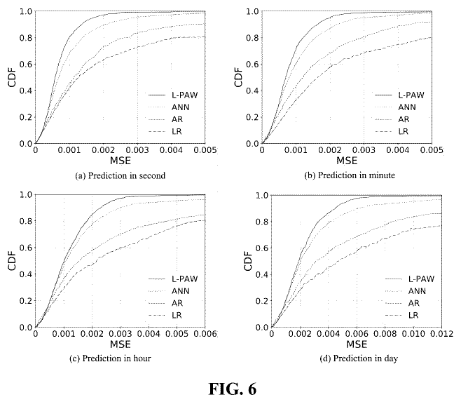

Compared to the LSTM, the GRU may achieve higher learning efficiency with fewer parameters. Unlike the conventional RNN, the GRU selectively reads and updates the previous information by using a gate structure. Therefore, the GRU only retains information useful for prediction and filters out irrelevant information. Meanwhile, the GRU automatically creates short links between different network layers by using gate structures, and directly transmits the previous information retained by it. Therefore, the GRU can solve the problem of gradient vanishing by re-parameterizing the conventional RNN [13] according to the settings of different gate structures. The core idea of the GRU is to make the hidden units to save some long-term memories, which enables the gradient to be progressed in many time steps. The GRU is a simplified form of the LSTM, that merges a forget gate and an input gate of the LSTM into one update gate. Therefore, the GRU includes two gates, namely, the update gate zₜ and a reset gate rₜ. As shown in FIG. 4, the structure of the GRU block in the proposed L-PAW is illustrated. Similar to the LSTM, an update mode of the two gates is on the basis of a current input xₜ^{c} and a previous hidden status ŷₜ₋₁. New memory content \tilde{y}ₜ is regarded as new information at current time t, where the reset gate rₜ is configured to control whether previous memory needs to be retained. In addition, the update gate zₜ is configured to control previous memory content ŷₜ₋₁ and the new memory content \tilde{y}ₜ to be forgotten or added.

Therefore, an output of the GRU block ŷₜ (the predicted workload) may be computed on the basis of the update gate zₜ. The complexity of Algorithm 2 is related to the model capacity (i.e., the number of parameters in the model), denoted as O(3(n²+nm+n)), where m is a size of the input, n is a size of the hidden layer, and there are three sets of operations requiring weight matrices in the GRU block (two sets of matrices for the update gate and the reset gate, and one set of matrices for the new memory content). Especially, the GRU is trained by using mini-batch stochastic gradient descent (SGD) to obtain higher accuracy.

Algorithm 2: Deep Learning Based Prediction
Algorithm For Cloud Workloads (L-PAW)

| | |
|---|---|
| 1. | Input: workload data \vec{X} = (x₁, x₂, ... , xₙ) |
| 2. | Initialize: a learning rate γ, a learning rate decay λ, a truncated number T, an |

epoch threshold Eₜ, and a batch size N_{bs}

| | |
|---|---|
| 3. | Call a TSA to compress X and obtain a new input \vec{X^{c}} = (x₁^{c}, x₂^{c}, ... , xₜ^{c}) |
| 4. | for each training epoch n = 1, 2, ..., N do: |
| 5. | Segment the epoch N, Eₜ = segment(N) |
| 6. | If n > Eₜ then: |
| 7. | γ = γ * λ |
| 8. | end |
| 9. | For each truncated number t = 1, 2, ..., T, do: |
| 10. | Update an update gate zₜ, zₜ = σ(W_{z} · [ŷₜ₋₁, xₜ^{c}]) |
| 11. | Update a reset gate rₜ, rₜ = σ(Wᵣ · [\hat{ŷ}ₜ₋₁, xₜ^{c}]) |
| 12. | Compute new memory content \tilde{y}ₜ, \tilde{y}ₜ = tanh(W · [rₜ · yₜ₋₁, xₜ^{c}]) |
| 13. | Output ŷₜ = (1 − zₜ) · ŷₜ₋₁ + zₜ · \tilde{y}ₜ of a GRU block |
| 14. | for i = 1, 2, ..., N_{bs} do: |
| 15. | Train GRU(W_{z}, Wᵣ, W) by using stochastic gradient descent (SGD) |
| 16. | end |
| 17. | end |
| 18. | end |

The integration of the TSA and the GRU block enables the classic RNN to learn the long-term memory dependence from the historical workload more effectively. Whenever historical memory is considered to be critical, the update gate is closed for reserving basic workload features in multiple time steps. Moreover, the reset gate enables the GRU block to reasonably utilize the model capacity through resetting when the memory does not need to be retained. Therefore, the proposed L-PAW is built on one simpler structure with fewer gates than the LSTM and may also achieve faster convergence than the GRU with the high-level representation of the workload data extracted by the proposed TSA. By contrast, the LSTM includes more gates and parameters, which requires a larger number of training samples and a longer time to train one good model. While the GRU may encounter the degradation of the learning efficiency due to the overuse of the hidden units in the classic SA.

### Embodiment 1

In this embodiment, the proposed model for cloud workload prediction is implemented on the basis of TensorFlow 1.4.0. Three real data sets are used in an experiment. The first one is Google cluster usage traces, which include running information of over 125,000 machines in a Google cloud data center on May 2011. The second one is Alibaba cluster traces, which include 4,000 machines with the runtime resource usage of 8 days. The third one is DUX-based cluster traces collected by Dinda. In the experiment, the CPU utilization is regarded as the main performance metric of the workload. More specifically, 1,000 machines are randomly selected from Google data sets within 29 days, where each machine includes about 100,000 traces. Similarly, 1,000 machines are randomly selected from Alibaba data sets within 8 days, where each machine includes about 7,000 recorded traces. Then, several basic metrics related to the workload prediction are extracted, including a machine identity (ID), start time, end time, CPU utilization, memory utilization, and disk input/output (I/O) utilization of each trace in the Google and Alibaba data sets. As the DUX-based cluster traces have been classified according to the features of workloads, two data sets are selected from two specific machines, where one machine includes 1,296,000 highly autocorrelated workload traces within 15 days, and the other machine includes 1,123,200 highly periodic workload traces within 13 days. The workloads of the Google and Alibaba cloud data centers exhibit more random features, while the workloads of DUX-based clusters exhibit higher autocorrelation and periodicity. An average size of workload examples of a host machine is about 8,000 after workload preprocessing. The data is input to the prediction model in batches. In more detail, the data set is randomly divided into three parts, namely, a training set (50%), a validation set (25%), and a test set (25%). The training set is configured for model training (calculating the weight of the neural network), the validation set is configured for model selection (choosing hyper-parameters and preventing overfitting), and the test set is configured for evaluating the performance of the selected optimal model. Moreover, the total number of training epochs is 100, the initial learning rate is 0.03, the number of truncated backpropagation steps is 32, and the batch size is 128.

Firstly, the performance of the proposed TSA for compressing the workload is evaluated in terms of the value of the cost function and the compression effect by using Google data sets with different numbers of top hidden units (where the value of k changes from 32 to 512). FIG. 4(a) illustrates that the value of the cost function drops dramatically after about 50 training epochs and gradually converges to different numbers of top hidden units. More specifically, the value of cost is higher when the number of top hidden units is smaller (e.g., k<64). Because the neural networks of the TSA have to be reconstructed massively to meet the compression requirements when the number of top hidden units is smaller. When the number of top hidden units is larger (e.g., k≥128), the value of the cost function has no obvious distinction under different numbers of top hidden units, as the network structure is ready to learn the basic feature representation from the raw workload data. Therefore, the number of top hidden units is set to be 128 (i.e., k=128), and this setting is used in the experiment below. Meanwhile, the workload data before and after use of the TSA is drawn under different settings of top hidden units. As shown in FIG. 4(b), (c), (d), (e) and (f), the TSA for workload compression is effective under the proper settings of the top hidden units, and it can provide an effective feature representation, that can greatly reduce the computational complexity of the proposed method for cloud workload prediction.

On the basis of the Google data sets and a preprocessed result of workload compression by using the TSA, the proposed L-PAW and other recent RNN-based methods for workload prediction are evaluated, including the recurrent neural network, the long short term memory, the gated recurrent unit, and an echo state network. The prediction accuracy and learning efficiency of these methods are compared and are measured by the MSE and the average training time, respectively. In general, the mean square errors of all these methods rise with the increase of prediction length. More specifically, for the second-level prediction, there is not much difference in prediction accuracy between the L-PAW and other RNN-based methods. With the increase of prediction length (from minute-evel prediction to day-level prediction), the L-PAW exceeds other RNN-based methods in terms of prediction accuracy and exhibits a bigger gap in performance improvement. This is because that the L-PAW may solve the problem of gradient vanishing and capture the long-term memory dependence from the historical workload. The results show that the L-PAW is more effective for workload prediction than other RNN-based methods under the high-dimensional and highly-variable cloud workload.

The proposed L-PAW is compared to other classic methods for workload prediction (including autoregression, linear regression, and an artificial neural network), and the prediction accuracy is measured by the MSE. FIG. 6 shows a cumulative distribution function (CDF) of the MSE under different methods for workload prediction with different levels of prediction length using the Google data sets. As shown in FIG. 6(a), for the second-level prediction, the value of the MSE obtained by the L-PAW is lower than that in all the other methods when the CDF is close to 1. As shown in FIGS. 6(b) and (d), with the increase of prediction length, the L-PAW achieves more significant performance improvement compared to other classic methods. This is because that these classic methods cannot effectively make the long-term prediction for the highly random workload without obvious regularity. By contrast, the L-PAW may better solve this problem, because it may extract the representative features from the raw workload data by using the TSA and capture the long-term dependence of the memory from the historical workload by integrating the GRU.

The above is only the preferred embodiment of the present disclosure. Any equivalent changes and modifications made according to the scope of patent application of the present disclosure shall fall within the scope of the present disclosure.

1. A deep learning-based method for predicting a high-dimensional and highly-variable cloud workload, comprising the following steps:
Step S1: obtaining historical workload data of a cloud data center, and carrying out preprocessing;
Step S2: on the basis of a raw data set, predicting a future workload of a central processing unit by using a deep learning based prediction algorithm for cloud workloads (L-PAW) integrating a top-sparse auto-encoder (TSA) and a gated recurrent unit (GRU), and transmitting a predicted result to a cloud service provider (CSP); and
Step S3: determining, by the CSP, a resource allocation strategy according to the predicted result, such that the cloud data center achieves load balancing.

2. The deep learning-based method for predicting a high-dimensional and highly-variable cloud workload according to claim 1, wherein the Step S1 specifically comprises:
Step S11: obtaining the historical workload data of the cloud data center, and extracting central processing unit (CPU) utilization as raw workload data, denoted as \vec{X}=(x₁, x₂, . . . , xₙ), wherein n∈ [symbol] , and xₙ is CPU utilization at that time; and
Step S12: normalizing the raw workload data.

3. The deep learning-based method for predicting a high-dimensional and highly-variable cloud workload according to claim 1, wherein the Step S2 of integrating the TSA and the GRU into a recurrent neural network (RNN) to obtain the L-PAW, specifically comprises:
replacing a hidden layer of the RNN with a GRU block on the basis of a basic feature representation of the workload extracted by the TSA; and
after the TSA is called to obtain a compressed workload, setting a learning rate decay λ to control a learning rate γ in stages;
wherein the GRU comprises two gates, namely, an update gate zₜ and a reset gate rₜ, and an update mode of the two gates is on the basis of a current input xₜ^{c} and a previous hidden status ŷₜ₋₁; new memory content \tilde{y}ₜ is regarded as new information of current time t, and the reset gate rₜ is configured to control whether previous memory needs to be retained; and the update gate zₜ is configured to control the previous memory content ŷₜ₋₁ and the new memory content \tilde{y}ₜ to be forgotten or added.

4. The deep learning-based method for predicting a high-dimensional and highly-variable cloud workload according to claim 3, wherein compressing the workload data on the basis of the TSA, and extracting a low-dimensional and essential feature representation of the workload data to serve as an input of load prediction, specifically comprises:
an input of the TSA being a vector \vec{X}=(x₁, x₂, . . . , xₙ) of a workload example, wherein n∈ [symbol] , and xₙ is CPU utilization at a time n;
during forward propagation, an average activation degree ρ of hidden units being computed as follows:
$$\hat{ρ} = \frac{1}{n} {\sum }_{i = 1}^{n} [ {a}^{( h )} ( {x}_{i} ) ]$$
wherein α^{(h)} is an activation function of the hidden layer;
next, all the hidden units being sorted according to respective \hat{ρ} values, and the first k hidden units being recognized, which are denoted as a vector τ=topₖ(\hat{ρ});
computing a cost function J_{TSA}(W, b)=J(W, b)+βΣⱼ₌₁^{k}KL(\hat{ρ}∥\hat{ρ}ⱼ) of the TSA, and compressed workload data xₙ=Wxₙ+b, wherein W is a weight and b is a bias; and
executing backpropagation of the cost function J_{TSA}(W, b) through τ=topₖ(\hat{ρ}).

5. The deep learning-based method for predicting a high-dimensional and highly-variable cloud workload according to claim 4, wherein the k hidden units with the highest activation degree are selected to reconstruct input data.
